(19) United States
(12) Patent Application Publication
(10) Pub. No.: US 2023/0148330 A1
(43) Pub. Date: May 11, 2023

(54) ORGANIC GLASS SCINTILLATORS

(71) Applicant: Radiation Monitoring Devices, Inc., Watertown, MA (US)

(72) Inventors: Urmila Shirwadkar, Burlington, MA (US); Kanai S. Shah, Watertown, MA (US); Edgar V. Van Loef, Watertown, MA (US)

(73) Assignee: Radiation Monitoring Devices, Inc., Watertown, MA (US)

(21) Appl. No.: 17/703,941

(22) Filed: Mar. 24, 2022

Related U.S. Application Data
(60) Provisional application No. 63/165,476, filed on Mar. 24, 2021.

(51) Int. Cl. C09K 11/06; C08K 3/08; C08K 3/38; G01T 1/20

(52) U.S. Cl. CPC C09K 11/06; C08K 3/08; C08K 3/38; G01T 1/2018; C08K 2003/0818

(57) ABSTRACT

Organic glass scintillator materials as well as corresponding methods and systems are described.

### RELATED APPLICATIONS

This application claims priority to U.S. Provisional Application No. 63/165,476, filed Mar. 24, 2021, which is incorporated herein by reference in its entirety.

### FIELD OF INVENTION

The disclosure generally relates to organic glass scintillators as well as corresponding systems and methods.

### BACKGROUND

Scintillators are widely-used as detectors for spectroscopy of energetic photons (e.g. X-rays and gamma rays) as well as neutrons. These detectors are commonly used in nuclear and high energy physics research, medical imaging, diffraction, non-destructive testing, geological exploration, and other applications. Important properties for the scintillator materials used in these applications can include high light output, high gamma-ray stopping efficiency (attenuation), fast response, low cost, good proportionality, minimal afterglow, and/or pulse shape discrimination (PSD). Thus, there is continued interest in the search for scintillator materials that have these properties.

There has been limited investigation of certain organic glass materials as scintillators. Certain such organic glass materials have had certain property limitations (e.g., in connection with detecting neutrons) while showing potential attributes. Thus, there is a need for organic glass scintillator materials that exhibit a good balance of detection properties including improved ability to detect neutrons and to distinguish between neutrons and gamma rays.

### SUMMARY

Organic glass scintillator materials as well as corresponding methods and systems are described.

In one embodiment, an organic glass scintillator material includes one or more additives. The additive may comprise a metal such as tin and/or lead. The additive may comprise boron. The additive may comprise lithium.

In another embodiment, the organic glass scintillator material is a polymer organic glass scintillator. The polymer may be, for example, polystyrene, polycarbonate or other suitable polymers. The additive may comprise a metal such as tin and/or lead. The additive may comprise boron. The additive may comprise lithium.

In another embodiment, a system for detecting radiation includes a detector with an organic glass scintillator material. The organic glass scintillator material includes one or more additives. The detector also includes a light detector assembly coupled to the scintillator material to detect a light pulse luminescence from the scintillator material.

In yet another embodiment, a method of radiation detection includes: providing a detection system comprising: an organic glass scintillator material including one or more additives; and a detection assembly coupled to the scintillator material to detect a light pulse luminescence from the scintillator as a measure of a scintillation event; positioning the system such that a radiation source is within a field of view of the system so as to detect emissions from the source; and measuring a scintillation event luminescence signal from the scintillator material with the detection assembly.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

FIG. 1A includes light yield data for the organic glass scintillator sample showed in FIG. 1B.

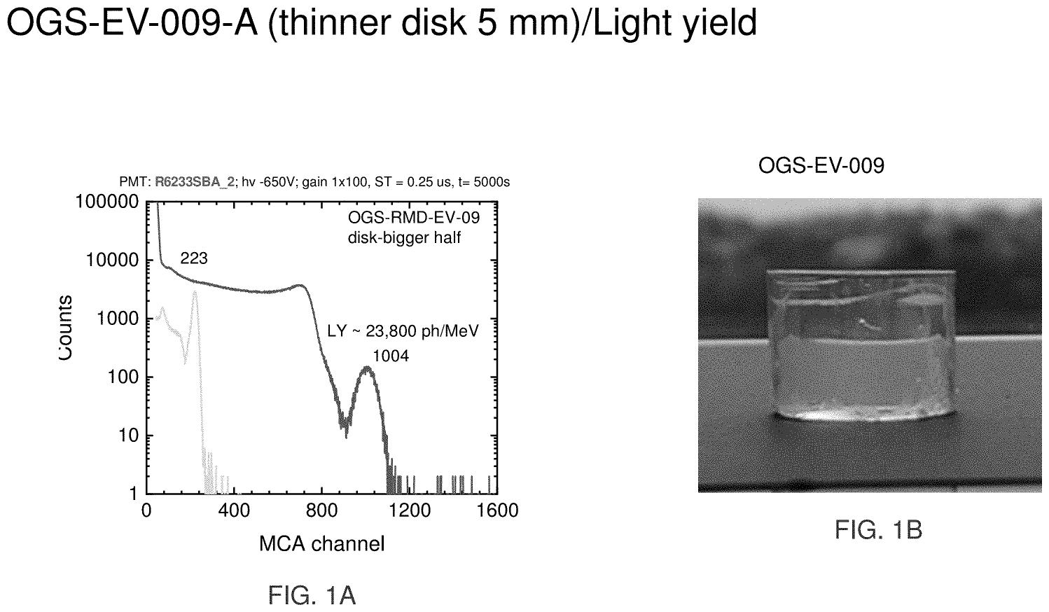

FIG. 2 shows ER data for the sample showed in FIG. 1B.

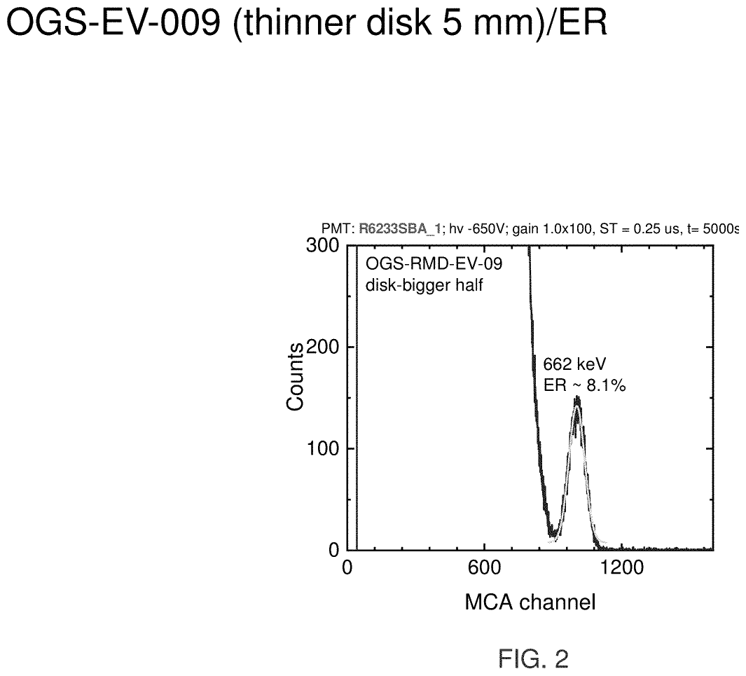

FIG. 3 shows PSD data from a tin-loaded organic glass scintillator sample.

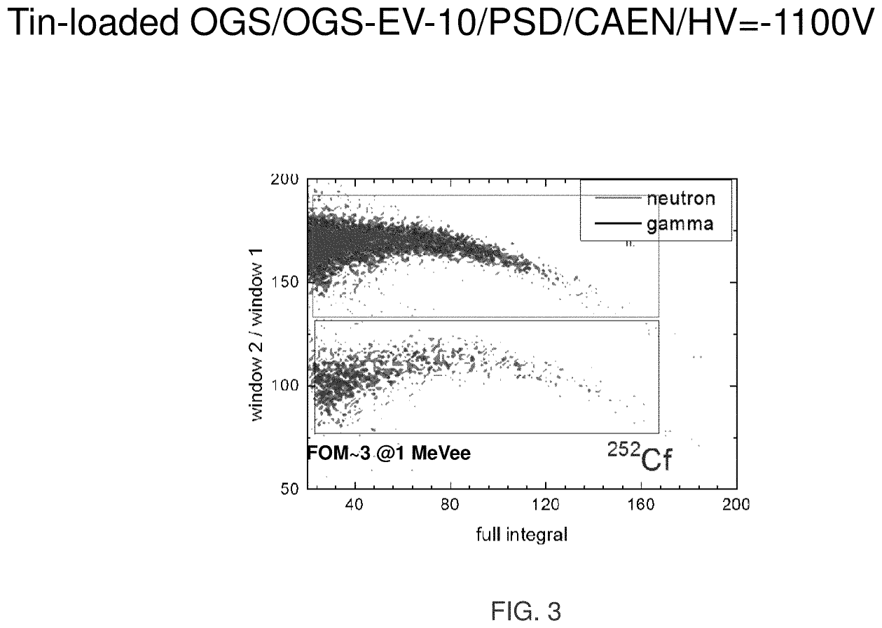

FIG. 4 shows light yield data from a tin-loaded organic glass scintillator sample.

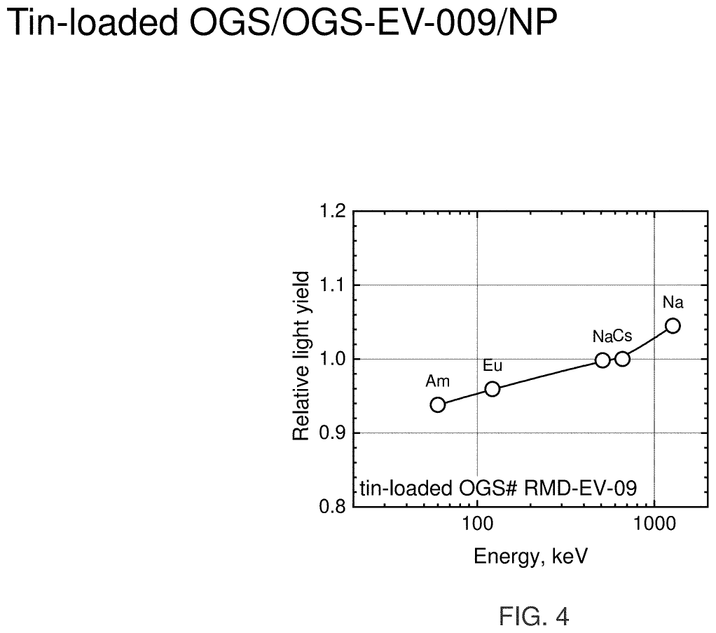

FIG. 5 shows decay data from a tin-loaded organic glass scintillator sample.

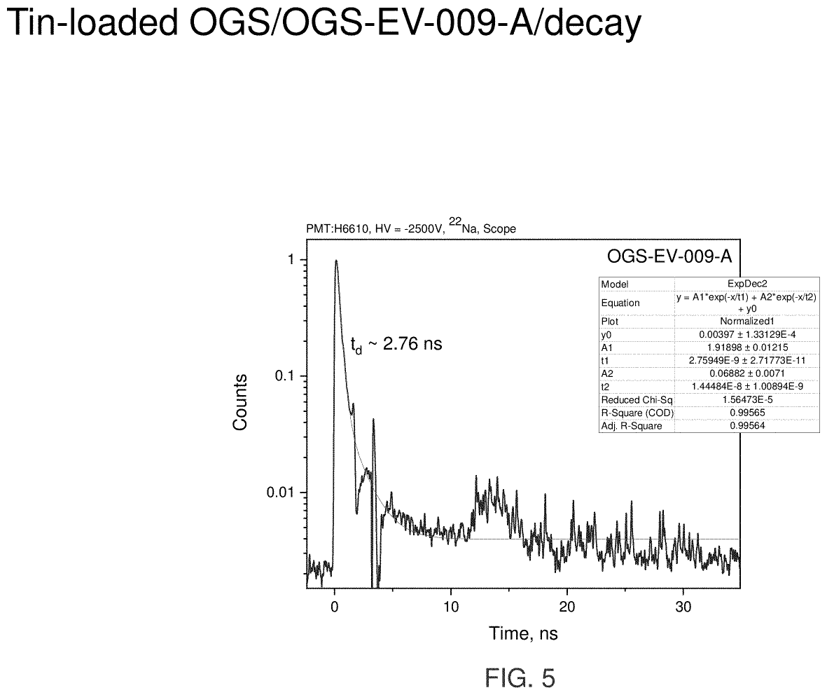

FIGS. 6A and 6B show a boron-loaded organic glass sample and 6C shows data obtained from the sample shown in FIGS. 6A and 6B.

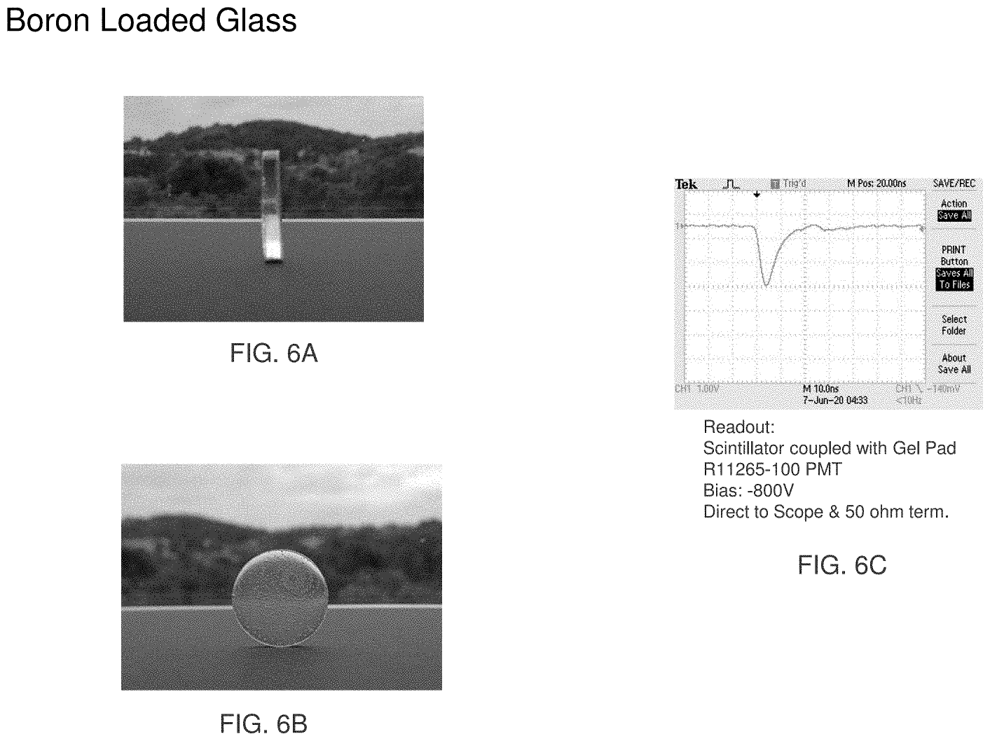

FIG. 7A shows spectroscopy data from a boron-loaded organic glass sample and FIGS. 7B and 7C show equipment used to obtain the data in FIG. 7A.

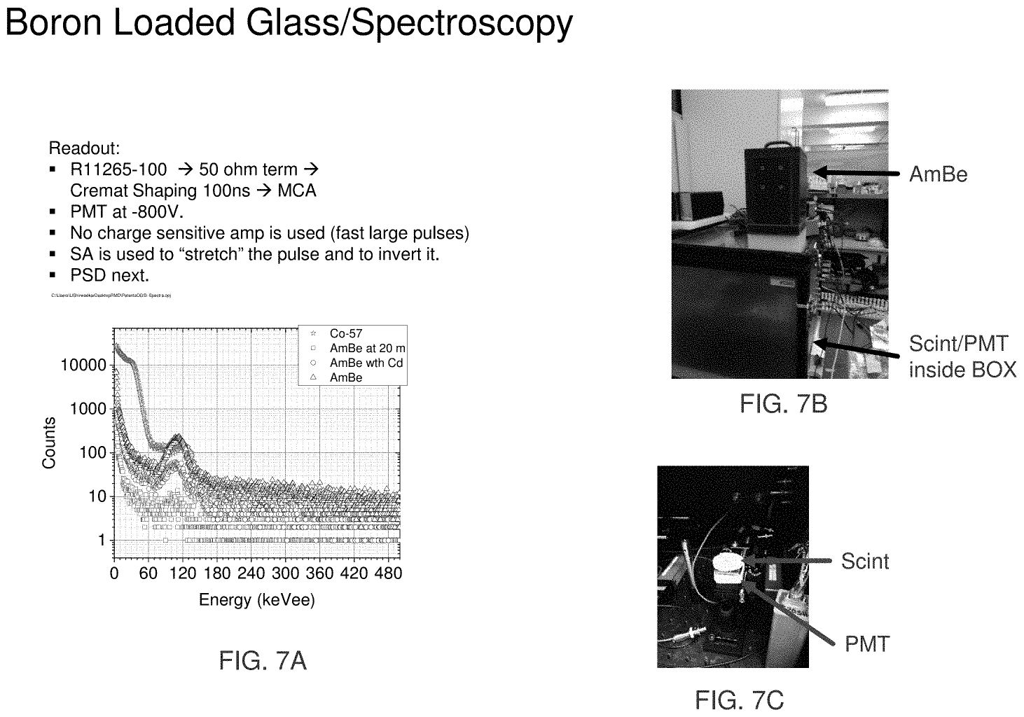

FIG. 8 shows PSD data of a boron-loaded organic glass sample.

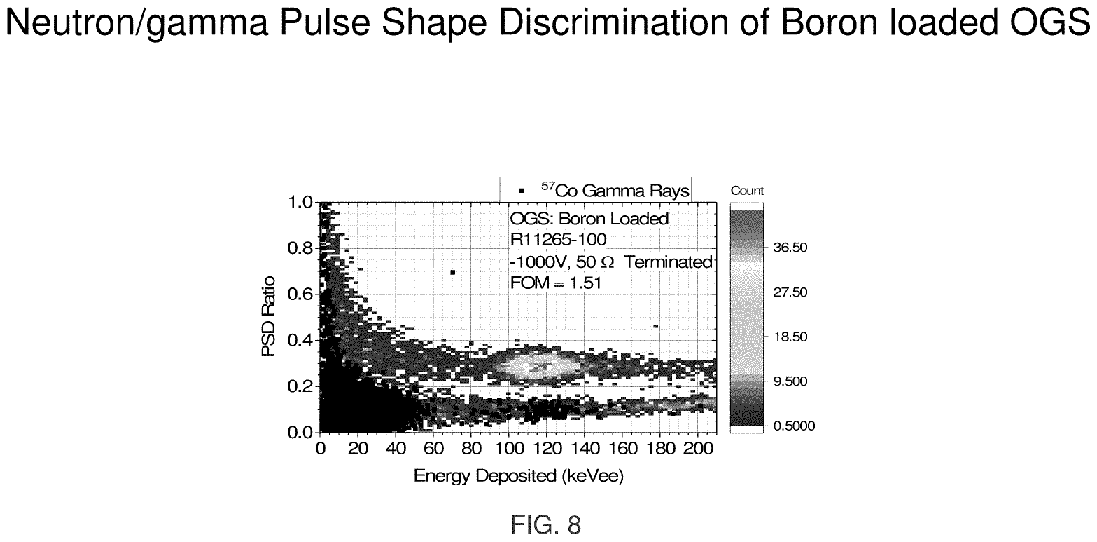

FIG. 9 shows neutron detection efficiency of a boron-loaded organic glass sample.

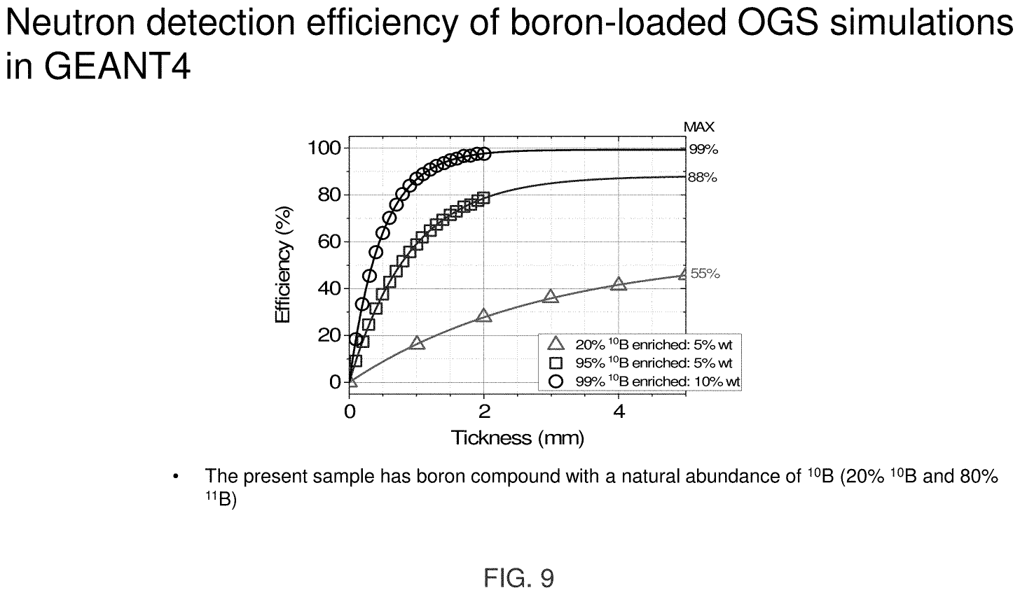

FIG. 10A shows a boron-loaded organic glass sample and FIGS. 10B and 10C show data obtained from the sample in FIG. 10A.

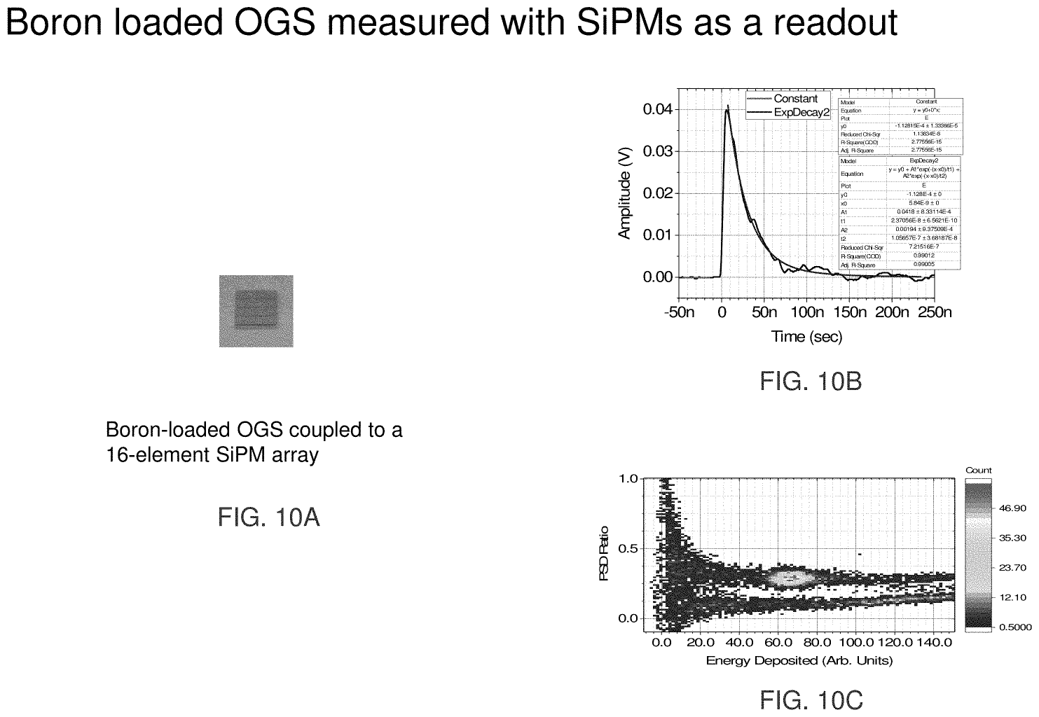

FIG. 11 shows suitable lithium-based additives.

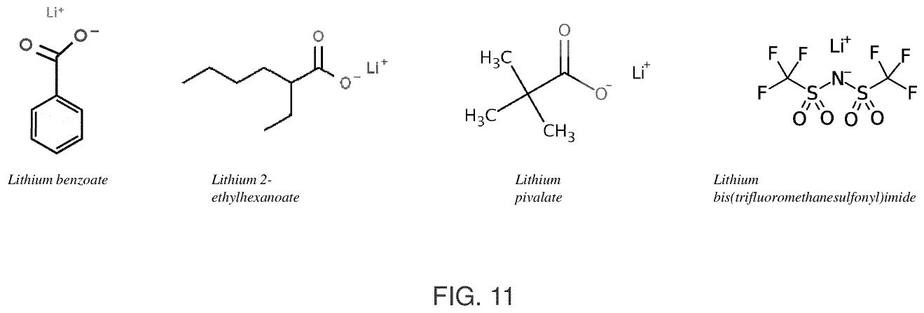

### DETAILED DESCRIPTION

Organic glass scintillator materials as well as corresponding methods and systems are described. As described further below, the organic glass scintillator materials may include one or more additives. In some embodiments, the organic glass scintillator material is a polymer organic glass scintillator. The additives may comprise a metal such as tin and/or lead. The additive may comprise boron. The additive may comprise lithium.

The additive(s) may enhance certain properties that may be advantageous, for example, in detector applications. For example, the organic glass scintillator materials may exhibit high light yields, excellent energy resolution, good decay times, good thermal neutron detection and improved ability to detect neutrons as well as to distinguish between neutrons and gamma rays, amongst other attributes.

Organic glass scintillator materials are known. For example, organic glass scintillator materials and methods of making the same have been described in “Melt-Cast Organic Glasses as High-Efficiency Fast Neutron Scintillators”, by Joseph S. Carlson and Patrick L. Feng, Nuclear Instruments and Methods A (Manuscript ID: NIMA-D-16-00614R2); “Taking Advantage of Disorder: Small-Molecule Organic Glasses for Radiation Detection and Particle Discrimination” by Joseph S. Carlson, Peter Marleau, Ryan A. Zarkesh and Patrick L. Feng, J. Am. Chem. Soc. 2017 139, 9621-9626; and, “Melt-Cast Organic Glasses as High-Efficiency Fast Neutron Scintillators” by Joseph S. Carlson and Patrick L. Feng, Nuclear Instruments and Methods in Physics Research A 832 (2016) 152-157; all of which are incorporated by reference in their entireties. It should be understood that any suitable organic scintillator material may be used in connection with the embodiments described herein.

In some embodiments, the organic glass scintillator material is a polymer organic glass scintillator. The polymer may be, for example, polystyrene, polycarbonate or other suitable polymers.

As noted above, the organic glass scintillator materials include one or more additives. In some embodiments, the additive may comprise a metal such as tin and/or lead. The additive may comprise boron. For example, when the additive comprises boron, ¹⁰B and/or ¹¹B may be present (e.g., 20% ¹⁰B, 80% ¹¹B). In some cases, up to 100% ¹¹B may be present. In some embodiments, the additive may comprise lithium. For example, lithium may replace some of the boron present in the additive in some cases.

In one embodiment, the additive may be present in the scintillator in any appropriate amount. For example, the additive may be present in the scintillator material in an amount of at least about 5 weight percent, at least about 10 weight percent, at least about 20 weight percent, at least about 30 weight percent, or at least about 40 weight percent. In some embodiments, the heavy metal may be present in an amount in the range of about 5-20 weight percent, about 5-30 weight percent, about 5-40 weight percent, about 10-20 weight percent, about 10-30 weight percent, about 10-40 weight percent, or about 20-40 weight percent.

In some cases, the additive (e.g., metal) may be a chemical compound (e.g., a metal compound). The compound may, in some embodiments, be an organometallic compound (e.g., a compound comprising at least one bond between a carbon atom and a metal atom). Examples of suitable tin-based compounds include, but are not limited to, tetracyclohexyltin, tetraphenyltin and allytriphnyltin, amongst others. Examples of suitable boron compounds includes ortho-Carborane and boric acid. Examples of suitable lithium compounds (e.g. organolithium compounds) include lithium benzoate, lithium 2-ethylhexanoate, lithium pivalate and lithium bis(trifluoromethanesulfonyl)imide.

In some embodiments, the organic glass scintillators may include other additives such as wavelength shifters in addition to those described above. The additives (e.g., wavelength shifters) may be added to the composition in suitable weight percentages for their intended purpose.

One of the valuable characteristics of at least some of the embodiments of the presently disclosed organic glass scintillators is the ability to differentiate neutrons from gamma rays. The timing profile of a gamma-ray scintillation event differs compared to a neutron scintillation event. For incident gamma rays, scintillation is very fast, including a fast light decay. In contrast, a neutron scintillation event exhibits a relatively slower timing profile. The difference in the timing profile between gamma-ray scintillation events and neutron scintillation events can facilitate differentiation between gamma-ray detection and neutron detection. In particular, such differences enable gamma-ray detection and neutron detection to be differentiated using pulse shape discrimination (PSD) analysis. PSD analysis, in general, involves comparing the luminescence signal pulse shape resulting from gamma-ray detection to the luminescence signal pulse shape resulting from neutron detection. In some embodiments, it may be advantageous to use PSD analysis over relatively long time periods to differentiate gamma-ray detection and neutron detection. Relatively long PSD times are particularly useful in embodiments when the scintillator is relatively thick, for example, greater than 1 cm, greater than 5 cm, etc.

To obtain a numerical metric of PSD performance, a figure of merit (FOM) may be calculated. The FOM may be obtained from a PSD histogram (e.g., a plot of the ratio of charge in the tail of a pulse to the total charge associated with the pulse as a function of counts). The FOM may be calculated from the PSD histogram as a ratio of the distance between the peak positions (PP) of the gamma-ray and neutron distributions to the sum of the full widths at half maximum (FWHM) for the distributions:

FOM=(PPₙₑᵤₜᵣₒₙ−PP_{gamma})/(FWHM_{gamma}+FWHMₙₑᵤₜᵣₒₙ).

In some embodiments, the FOM is at least about 1, at least about 2, at least about 2.5, at least about 2.6, at least about 3, or at least about 3.5 at a cut-off energy of about 1 MeVee (MeV electron equivalent). The FOM may be in the range of about 1 to about 2, about 1 to about 3, about 1 to about 3.5, about 2 to about 3, about 2 to about 3.5, or about 2.5 to about 3.5 at a cut-off energy of about 1 MeVee.

In some embodiments, the organic glass scintillators have high gamma-ray energy resolution. Energy resolution generally refers to the ratio of the full width at half maximum (FWHM) of a given peak (e.g., photopeak, total absorption peak) to the peak position, and it is generally expressed as a percentage. Generally, it is advantageous for a scintillator to have high energy resolution (e.g., a low energy resolution percentage). For example, the better the resolution (e.g., the smaller the photopeak width) of a scintillator, the closer in energy two gamma rays can be while appearing as distinct photopeaks in a pulse height spectrum. That is, a scintillator with improved energy resolution will generally have improved ability to distinguish between ionizing radiation of different energies. This may be particularly advantageous in certain scintillator applications. For example, in the context of active screening of cargo for fissile materials, low gamma-ray energy resolution may require setting an energy threshold higher to avoid detecting background signals (e.g., 2.6 MeV signals from ²²⁸Th), thus decreasing overall system detection efficiencies.

In some embodiments, the organic glass scintillators advantageously have high gamma-ray stopping efficiency. Gamma-ray stopping efficiency generally refers to the percentage of gamma rays a scintillator is able to interact with and detect.

The organic glass scintillators described herein may also have high light yield (e.g., a light yield of at least about 10,000 photons/MeV). Light yield generally refers to the number of photons that are emitted from a scintillator per unit of energy detected.

The organic glass scintillator material compositions described herein may be used in detectors. The detector may include one or more scintillators optically coupled to a light detector assembly, such as a light photodetector, or imaging device, or other appropriate light sensitive detector. The detector assembly may include a data analysis system to process information from the scintillator and light sensitive detector. Non-limiting examples of a light detector assembly include photomultiplier tubes (PMT), photodiodes, CCD sensors, image intensifiers, and the like. Choice of a particular light detector assembly will depend in part on the type of radiation detector being fabricated and on its intended use of the device. In certain embodiments, the photodetector may be position-sensitive. In use, the detector detects energetic radiation emitted from a source.

The detector assemblies themselves, which may include the organic glass scintillator material and the light detector assembly, may be connected to a variety of tools and devices. Non-limiting examples include monitoring and detection devices, well-logging tools, and imaging devices such as X-ray CT, X-ray fluoroscopy, X-ray cameras (such as for security uses), PET, and other nuclear medical imaging or detection devices. The above examples are merely illustrative of the types of application the current composition may be used for and should not be interpreted to limit the use of the present material in other appropriate applications. Various technologies for operably coupling or integrating a radiation detector assembly containing a scintillator to a detection device may be utilized.

A data analysis system may be coupled to the detector. The data analysis system may include, for example, a module or system to process information (e.g., radiation detection information) from the detector/light detector assembly. The data analysis system may also include, for example, a wide variety of proprietary or commercially available computers, electronics, systems having one or more processing structures, or the like. The systems may have data processing hardware and/or software configured to implement any one (or combination of) the method steps described herein. The methods may further be embodied as programming instructions in a tangible non-transitory media such as a memory, a digital or optical recording media, or other appropriate device.

1. A scintillator material comprising an organic glass scintillator material comprising one or more additives.

2. The scintillator material of claim 1, wherein the additive comprises a metal.

3. The scintillator material of claim 2, wherein the additive comprises tin.

4. The scintillator material of claim 2, wherein the additive comprises lead.

5. The scintillator material of claim 1, wherein the additive comprises boron.

6. The scintillator material of claim 2, wherein the additive comprises lithium.

7. The scintillator material of claim 1, wherein the organic glass scintillator material comprises a polymer organic glass scintillator material.

8. The scintillator material of claim 7, wherein the polymer comprises polystyrene or polycarbonate.

9. A system for detecting radiation comprising:
a detector comprising the scintillator material of claim 1,
a light detector assembly coupled to the scintillator material to detect a light pulse luminescence from the scintillator material.

10. A method of radiation detection comprising:
providing a detection system comprising:
a scintillator material of claim 1; and
a detection assembly coupled to the scintillator material to detect a light pulse luminescence from the scintillator as a measure of a scintillation event;
positioning the system such that a radiation source is within a field of view of the system so as to detect emissions from the source; and measuring a scintillation event luminescence signal from the scintillator material with the detection assembly.
